(19) United States
(12) Patent Application Publication
(10) Pub. No.: US 2009/0325128 A1
(43) Pub. Date: Dec. 31, 2009

(54) METHOD RELATING TO IMPLANTS, AND A MACHINE-READABLE MEDIUM AND A COMPUTER

(75) Inventors: Stephan Holzner, Hohenschaftlarn (DE); Gerhard Weber, Purgen (DE); Thomas Gleixner, Augsburg (DE)

Correspondence Address: RISSMAN HENDRICKS & OLIVERIO, LLP, 100 Cambridge Street, Suite 2101, BOSTON, MA, 02114, US

(73) Assignee: Straumann CAD/CAM GmbH (previous known as"etkon Centrum fur dentale CAD/CAM-Technologie AG), Grafelfing (DE)

(21) Appl. No.: 12/523,126

(22) PCT Filed: Jan. 10, 2008
(86) PCT No.: PCT/EP08/00154

§ 371 Date: Sep. 4, 2009

(30) Foreign Application Priority Data
Jan. 15, 2007 (DE) 10 2007 002 144.7

(51) Int. Cl. A61C 13/08; G06F 17/50

(52) U.S. Cl. 433/201.1; 703/1; 700/98; 700/117; 700/159

(57) ABSTRACT

Method according to which an individual implant (19) is modelled taking into account the individual shape of a tooth (2) and/or a hole (6) in a jaw-bone (3).

### FIELD OF INVENTION

The present invention refers to a method relating to dental implants.

### BACKGROUND

It is known that an implant with a screw shape is screwed into a jaw. To this end a corresponding hole must be drilled into the jaw. Mountings, abutments, or the like, can be provided on such an implant for holding denture parts, such as bridges, caps, crowns, or the like.

### SUMMARY OF THE INVENTION

It is the object of the present invention to provide an improved method, devices therefor, and implants improved thereby.

According to one embodiment of the invention, a method is provided comprising modeling an individual implant taking into account the individual shape of a tooth and/or a hole in a jawbone.

According to another embodiment, a computer-readable medium is provided with instructions to a computer for executing the above method.

According to another embodiment, a computer is provided with the above computer-readable medium.

Preferred embodiments are disclosed in the description and claims.

In the method an implant is individually modeled, i.e. depending on the individual shape of the tooth or a hole in a jawbone.

The tooth may be a natural tooth. In such a case the hole is then also a naturally shaped hole (alveole). A hole, however, may also be created artificially, e.g. by drilling.

After extraction of a tooth or tooth residue a hole remains in the jawbone. In the method either the shape of the tooth or the shape of the hole is taken into account for modeling an individual implant. Here, when the implant is being shaped, the form of the tooth or the hole can be taken into account as accurately as possible so that an implant can be modeled showing a good primary and a good secondary stability. The primary stability follows from the shape of an implant, for instance from the screwed-in thread in prior-art implants, the secondary stability following from the ingrowth of the implant in the bone due to bone growth.

The individual shape of the implant is of relevance especially in the region inserted into the jawbone. This part is of importance to a good primary stability and a fast and good secondary stability, respectively. For the part of the implant projecting from the jawbone, an individual shape is also advantageous as it is thereby possible to take into account the existing situation made up of neighboring teeth, neighboring denture parts, counter bite, etc., with an adaptation that is as good as possible. Likewise, the shape of the original tooth can also be taken into account.

For modeling the implant the individual shape of the tooth or the hole in the jawbone can be stored in a data set, said data set being used by a software for modeling the implant.

This enables a computer-assisted modeling where large data volumes can be processed in a precise way.

The data set describing the shape of the tooth or the hole in the jawbone can be obtained in different ways. For instance, it is possible to scan an extracted tooth (cleaned). Based on the shape of the tooth, the shape of the hole in a jawbone, into which an implant is to be inserted, is in principle also known since the shape of the tooth and the shape of the corresponding hole in the jawbone are matching, with a small gap, in which holding fibers for the tooth are provided (part of the periodontium), remaining between tooth and bone as a rule.

The shape of an extracted tooth can be sensed with an optical or mechanical probe.

Instead of the tooth itself, it is also possible to use a model or casting of the tooth (e.g. a plaster model).

However, it is also possible to scan a tooth that has not been extracted yet, or a hole in which the tooth is still positioned, e.g. by computer tomography. X-ray tomography, but also for example NMR tomography may here be employed.

It is also possible to measure the hole created by the extraction of a tooth, or another existing hole, optically, mechanically or by computer tomography (X-ray, NMR). A cast or model of said hole (for instance with a plaster model) can also be scanned.

For modeling the implant the data set of the tooth or the hole in the jawbone is displayed in the modeling of the implant. For instance, the surface of a tooth or the hole can be shown as in a three-dimensional view on a two-dimensional screen. The view may be transparent or nontransparent. It is also possible to display sections of the tooth or the hole.

For the software-assisted modeling of the implant it is advantageous when the software automatically generates a proposal for the shape of the implant or at least for a part thereof. For instance, the shape of the root or a part of the root of the tooth or of the hole can here be adopted as the desired shape of the corresponding part of the implant. The adoption of the shape yields an individual implant. When the shape is adopted, it is possible to take into account some clearance, i.e. the implant or the part thereof that is inserted into the jawbone is modeled slightly reduced in size in comparison with the hole in the bone. The play may e.g. be 0.001, 0.005, 0.01, 0.05, 0.1, 0.2 or 0.5 mm.

In such a method it is further advantageous when the insertability of the implant is checked or taken into account. For instance, there may be tooth root shapes that due to the shape of the corresponding hole in the jaw cannot be inserted without difficulty. This may easily happen particularly with molars or wisdom teeth since several roots may here point into several directions. Such a problem hardly arises with incisors or canines.

It is also possible that the software makes several proposals for implants, among which one can then be chosen. It is here advantageous when at least two different proposals are made that consist of a different number of implant parts.

Of advantage is also an embodiment in which a surface roughness or surface structure is provided for an implant. Such roughnesses or structures, e.g. grooves, knobs, or the like, improve stability through a splined growing together with the bone. Such roughnesses can also be accomplished through a specific milling operation because a rapid milling operation yields rougher surfaces than a slow one. Hence, a rapid milling operation may also be of advantage to a rough surface (apart from a faster fabrication). Moreover, a special method step may be taken for creating surface roughness, e.g. sand blasting, salt blasting, or the like, grinding with sandpaper or brushes.

The result of the modeling operation is preferably a data set indicative of the shape of the implant.

A part of the implant may also be intended for mounting an abutment or another mounting structure. A given data set can be used for such a part of the implant. Said data set may be stored in a database or a library or in another file.

Apart from the shape of the hole or the shape of the tooth, a data set may also be taken into account that describes at least a part of the shape of the jawbone next to the hole into which the implant is to be inserted. It can thereby for instance be checked whether stability problems might arise from the jaw due to the insertion of the implant. Such problems can e.g. be checked with a “finite element method”.

Apart from the implant, it is further possible to model a counterpart that can be mounted on an outwardly oriented part of the implant. An outwardly oriented part is e.g. one that is oriented away from the part that is to be inserted into the jawbone. This may e.g. be the masticatory surface or the part on which an abutment or another mounting is to be installed. However, it may also be that part that is to be covered to replicate a natural tooth. The counterpart is adapted in its shape preferably individually to the implant. It may e.g. have an area that is matched in its shape to the part of the implant, on which the counterpart is to be mounted, such that a planar contact is achieved (even with an uneven or irregularly formed surface of the counterpart or implant, respectively).

With such a counterpart an implant can for instance easily be inserted into a jawbone as the implant itself can be pressed into the jawbone or into the corresponding hole by applying pressure on the counterpart. It is also possible to hammer in the counterpart without the risk that the implant itself will thereby get damaged.

Furthermore, a method is of particular advantage wherein a part of the implant which is to substitute a tooth root portion is made integral with such a part of the implant that is used as a cover or is to be connected to an abutment or another mounting. It is thereby possible to implement the function of the implant and an abutment, as known from the prior art, with a single piece, resulting in a particularly high stability.

Furthermore, the implant can also fully correspond to the shape of the original tooth or fully to the shape of the tooth crown of the original tooth. This means that it is e.g. manufactured in a CAM method such that it can be inserted into the jaw without any further veneer. To this end the implant need also not exactly match the original tooth in the area of the tooth crown, but can also have a different tooth crown shape that assumes the function of a complete tooth. With these implants no space can e.g. be left for veneers. The implant can thus e.g. be formed directly with the masticatory surface. Masticatory surfaces are e.g. in molars or in wisdom teeth the dental surfaces (which are horizontal and lie transverse to the tooth axis) used for grinding, and in canines and incisors the ends that project from a jaw to the furthest extent.

Implants that already include the masticatory surface and/or at least in the area of the tooth crown fully correspond to the original tooth or to a tooth of equal function are furthermore preferably completely unitary or at least made unitary with at least one, several or all root substitute portions of the implant. This permits a good stability of the implant.

In a method a modeled implant, as described above or further below, is manufactured in a computer aided manufacturing (CAM) method, such as e.g. milling.

It is advantageous when with the same, an equal or a different manufacturing method a counterpart (also see above or further below) is also fabricated. It may here e.g. be advantageous when the material of the implant is a very hard material, such as ceramics or titanium, but the counterpart is made from a softer material, e.g. plastics, or the like. When the implant is e.g. pressed or hammered in, this accomplishes a good pressure distribution on the surface of the implant, thereby reducing the risk of breakage or deformation of the implant during insertion.

As for ceramics that are dense-sintered after machining (milling), a corresponding data set of the implant can be increased so that after dense-sintering the desired shape (reduced in size in comparison with the prepared (milled) shape) is obtained.

In general, different materials are suited for the implant, for instance a metal, titanium, titanium with a grade 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33 . . . (the grade information refers e.g. to the ASTM specifications), ceramics, zirconia ceramics, or doped zirconia ceramics. A material that corresponds or is similar to a tooth material, such as hydroxyapatite or also fluorapatite, or mixtures with these materials (also with further materials), is suited for the implant. The implant can further comprise different layers, coatings, or the like, made from different materials.

A freshly inserted implant is preferably disoccluded. To this end appropriate means, such as caps or bridgings, may also be manufactured in a CAD/CAM method.

Furthermore, an implant is preferably fixed in its position in which it is to grow in, at least during ingrowth, so that ingrowth can take place as fast and undisturbed as possible. The implants can be moved by the tongue or the counter bite, which slows down or suppresses the ingrowth process.

For such a fixation an adhesive may be provided e.g. on the root substitute portion of the jaw at least in some regions or also throughout the whole root substitute region. The adhesive can be applied in a corresponding method step, e.g. by immersion into a liquid adhesive. The term adhesive shall also encompass so-called cements, as are used in dental technology. The adhesive can also be decomposed or dissolved in the patient's body, so that it will disappear during bone growth, thereby providing room for the bone growing process.

The implant may also be connected with the help of appropriate connecting means to the neighboring teeth. This will also fix the implant in the desired position. Said connecting means can also be made by CAD/CAM.

The method can be used for implants at dental positions of wisdom teeth, molars, canines or incisors.

### BRIEF DESCRIPTION OF THE DRAWINGS

Advantageous embodiments of the invention shall now be explained with reference to the attached figures, of which:

FIG. 1 shows a tooth in the jawbone;

FIGS. 2a and 2b show schematic sectional drawings of implants in the jawbone;

FIG. 3 is a schematic view showing data on a computer for modeling an implant;

FIG. 4 is a three-dimensional schematic view of an implant and of a counterpart;

FIG. 5 is a three-dimensional schematic view of an implant and a counterpart in a further embodiment;

FIGS. 6a, 6b and 6c show different surface structures of implants;

FIGS. 7a, 7b and 7c show different means for fixing an implant or for disoccluding an implant.

### DETAILED DESCRIPTION

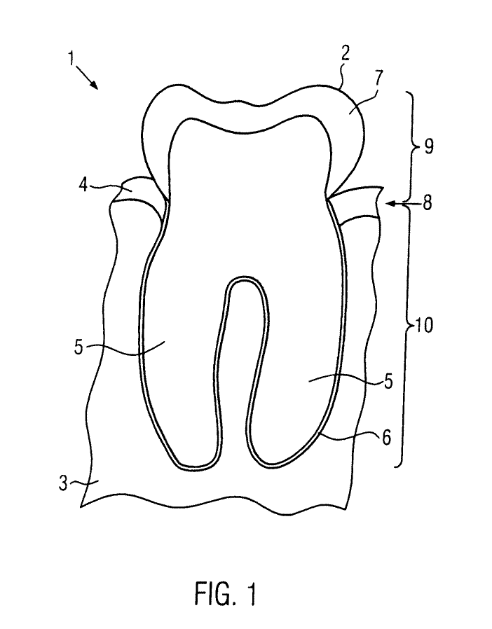

FIG. 1 shows a tooth in a jawbone 3. The roots 5 of the tooth 2 are positioned in a hole 6 in the jawbone. A gingival layer 4 is located on the jawbone 3.

The tooth neck 8 is positioned between the root portion 10 and the tooth crown portion 9.

The dental enamel bears the reference numeral 7.

The distance between the tooth 2 and the jawbone 3 is very small in reality. Fibers that connect the tooth to the bone are found in this gap.

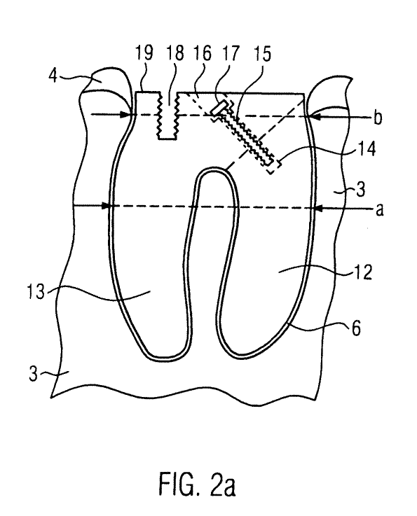

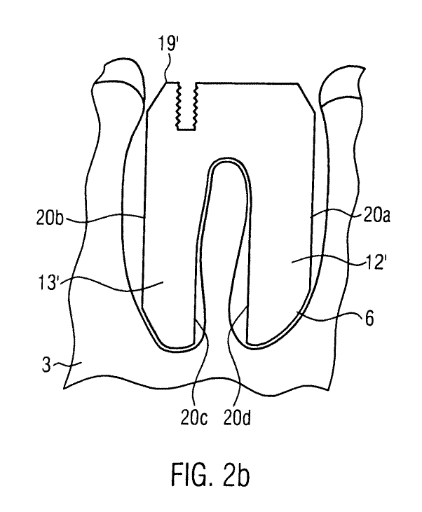

FIG. 2a gives an example how an implant may be shaped after the tooth 2 of FIG. 1 has been extracted. The implant 19 comprises two root portions 12, 13 having shapes that exactly match those of the roots 5 of FIG. 1

In FIG. 2a, the implant 19 substantially fills the space of the hole 6 in the jawbone 3. Since the implant 19 is relatively close to the bone 3, ingrowth can here take place very rapidly, which results in a secondary stability very rapidly.

As shown in FIG. 2, there may be cases where an implant 19 cannot be inserted into the hole 6 without difficulty. In the upper portion of the hole 6, there is a constriction (see reference numeral b), the extension of which is smaller than the broadest extension (see reference numeral a) of the implant 19. In such a case it may be expedient to make an implant from two parts, so that two parts 12 and 13 can be inserted independently of each other. To this end a separation shown in broken line is provided in the implant 19 in the upper right part. To interconnect the two implant parts, the root part 12 may comprise a thread 14 into which a screw 17 can be screwed, and the head of which in a space 16 can press the part 13 against the root part 12. Instead of screw and thread, other mechanical connecting means (e.g. an attachment) or also adhesive or cement is suited for connecting the parts 12 and 13.

In the upper end of part 13, a thread 18 is provided for tightly screwing e.g. an abutment. The head of the screw 17 is here countersunk to such an extent that it is not objectionable there.

In the same way as two parts 12, 13 are assembled in FIG. 2a to form an implant 19, it is also possible to provide even more parts. These parts need also not be interconnected by means of screws 17, but can be connected with the help of other connecting means, e.g. an attachment, cement, adhesive, or the like.

Furthermore, as can be seen in FIG. 2a, a part of the implant (environment of thread 18), which is connected to an abutment or a mounting, is connected to a part that represents root substitute (lower region of part 13).

FIG. 2b shows an alternative implant 19′, in which flat portions 20a, 20b are provided on the outer sides and flat portions 20c, 20d on the inner sides for ensuring insertability, the implant 19′, however, being then made of one part. The flat portions 20a, 20b, 20c, 20d are configured such that the implant 19′ can be pushed through the minimal opening of the hole 6 (see reference numeral b) in FIG. 2a) and can be pushed over the bone part between the two root substitute parts 12′, 13′. Although this results in a larger gap between the implant 19′ and the bone 3, so that the absence of corresponding implant material leads to a lower primary and secondary stability, on the other hand the implant 19′ can be made of one part, which enhances the stability of the implant itself. In this variant the implant also comprises portions—in the part that will be inserted into the jawbone—that match the shape of the hole (see e.g. lower ends 12′ and 13′), yielding a good primary and rapid secondary stability.

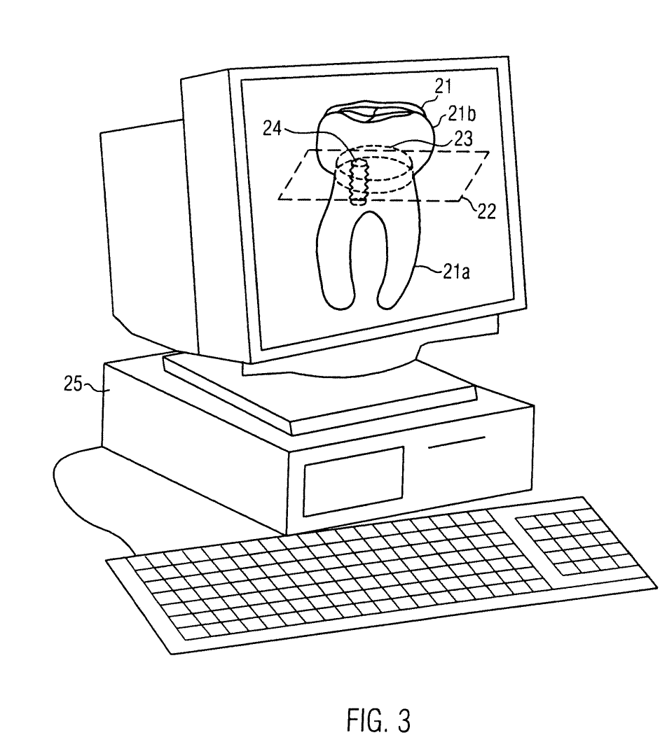

FIG. 3 shows a computer 25 displaying a data set 21 which describes the surface of a tooth 2. In the portion of the tooth neck an optional partition plane 22 is plotted that is to divide the data set 21 into an upper and a lower part. Plane 22 can also be displayed. The position of the plane 22 can be set by hand or can be suggested by the software automatically. The plane 22 separates that part of the data set 21 that is to be adopted as unchanged as possible from the part that is to be changed. The lower part 21 shall be adopted as unchanged as possible for the shape of the implant, so that the implant can be inserted into the hole 6 as accurately fitting as possible. In this portion, however, changes can also be made in the shape, e.g. flat portions, to accomplish e.g. insertability.

The upper part 21b (i.e. the portion corresponding to the part of a tooth crown) should be adapted to create possibilities of fastening for abutments or to create space for veneers so as to replicate the appearance of a natural tooth as much as possible.

Such veneers can e.g. be made from porcelain.

FIG. 3 schematically shows how a part 23 above the plane 22 is modeled cylindrically with an elliptical cross-section in which a thread 24 is provided into which e.g. an abutment can be tightly screwed.

The plane 22 may also be curved. It just serves as an optional modeling aid.

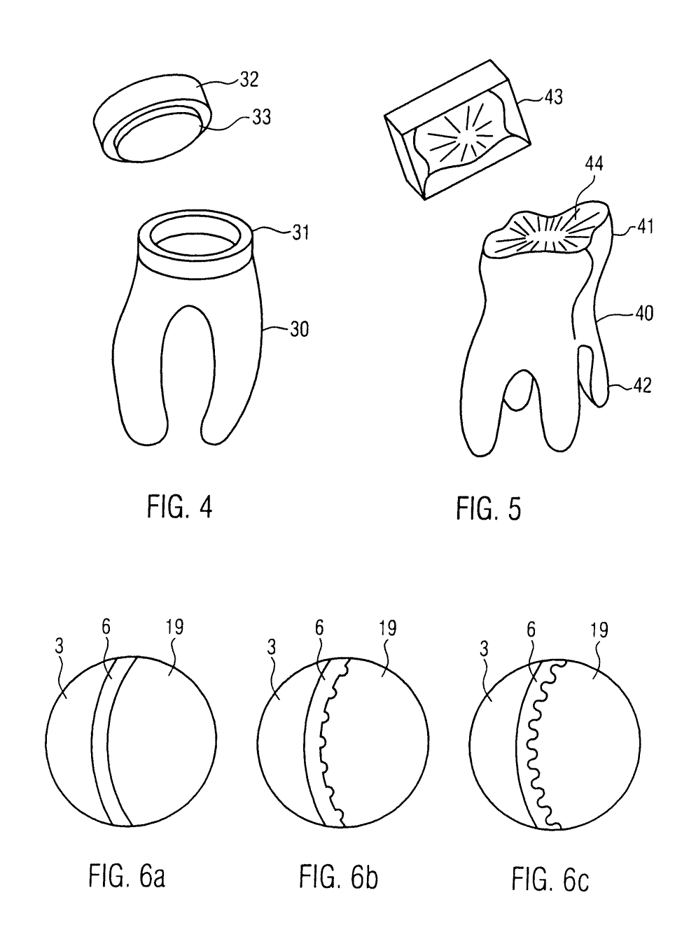

FIG. 4 shows a three-dimensional view of an implant 30 in which a specific geometrical shape 31 is schematically shown at the upper end. For instance, a ring-shaped rim is provided on the outer periphery of the implant. A counterpart 32 is formed at a side in such a way that it can be brought into contact with the upper side of the implant 30 over an area as large as possible. The counterpart 32 may e.g. be made from plastics. The implant can be driven into the jaw by strokes or by pressure applied to the counterpart 32.

FIG. 5 gives an example of an implant 40 in which an upper part 41 is provided that is intended for veneering, and a lower part 42 configured as a root substitute portion. The two parts are made unitary.

An example of an implant that fully corresponds to the shape of the original tooth, and thus also in the area of the tooth crown corresponds to the original tooth, is shown by the illustration in FIG. 1, on the assumption that the implant has the outer shape of the tooth 2. Such an implant can e.g. be completely formed from titanium or ceramics (preferably in one part). In the area of the tooth crown it may be formed in a different way, but in such a fashion that the implant assumes the full function of a tooth at the corresponding tooth position. The implant will then also include, for instance, a masticatory surface.

In this case the counterpart 43 has the shape of the surface 44, so that it can be mounted in planar contact with this surface 44. This counterpart 43 thus serves to hammer the implant 40 into a jaw.

FIG. 6 shows various surface configurations of the implant 19. In FIG. 6a, the surface is substantially smooth. FIGS. 6b, 6c show different surface roughnesses or flutes. When the space 6 shown in FIGS. 6a to 6c is overgrown with bone material 3, the flutes (see FIGS. 6b and 6c) provide for a particularly good grip of the implant 19 in the bone 3.

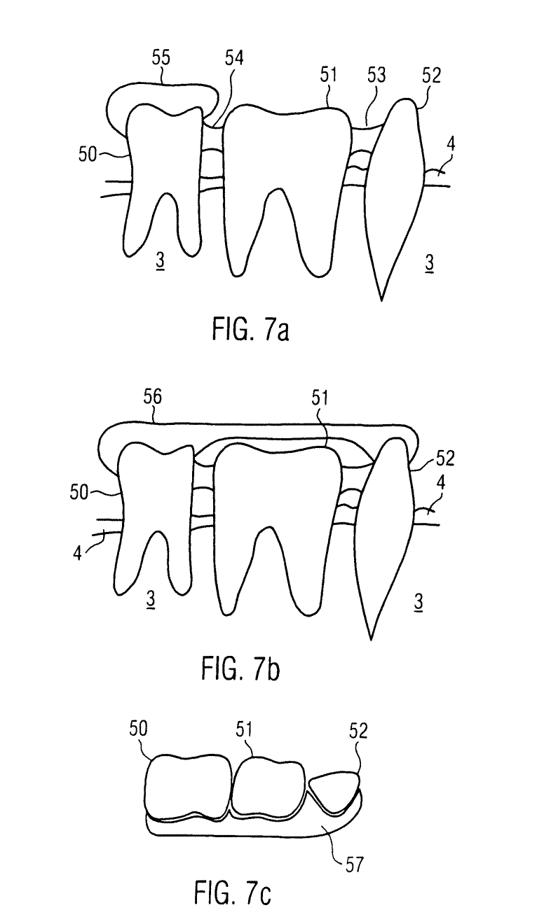

FIG. 7 shows means with which an implant can be fixed in its position. Here the implant bears reference numeral 51; reference numerals 50 or 52 stand for natural teeth. The implant 51 is held with coupling means 53, 54 on the teeth 50, 52. The coupling means 53, 54 are detachably connected to the implant and the teeth, e.g. glued on. They are only used temporarily for instance for about four to six weeks until ingrowth of the implant 51. The shape of the coupling means is given by the surface of the implant 51 and the teeth 50, 52.

FIG. 7a shows the tooth 50 with a mounting 55 provided thereon, which prevents the opposing jaw from getting into contact with the implant 51 during chewing. This prevents the exertion of pressure on the implant 51 by the counter bite.

FIG. 7b shows a bridging 56 of the implant 51 as a means for disoccluding the implant. The bridging 56 is supported on the neighbors 50, 52 and bridges the position of the implant. This protects the implant 51 even in a better way against the pressure exerted by the opposing jaw. The bridging 56 can be adhesively fixed with cement or adhesive temporarily (for some weeks) onto the neighbors 50, 52.

FIG. 7c shows a variant of a means for fixing the implant 51 in its desired position. The teeth 50, 52 are viewed from above along the tooth axis. A fixation 57 is fastened to the outside or inside of the teeth 50, 52 (temporarily, possibly with adhesive or cement) and the implant 51 is fastened to said fixation (temporarily, possibly with adhesive or cement). Owing to this fixation the implant 51 can readily grow in in its position. In addition to the fixation 57, a cap 55 or a bridging 56 may be provided as a means for disoccluding the implant.

The cap 56, the coupling means 53, 54, the bridging 56 or the fixation 57 (i.e. in general means for fixing the implant in its position or for disoccluding the same) have each portions that get into contact with the teeth or the implant to be fastened on or to said teeth or implant. To this end it is advantageous when the means are manufactured by way of CAD/CAM to adapt the portions as exactly as possible to the shape of the teeth or the implant. The shape of the implant is known from modeling. The shape of the neighbors (teeth or other implants or denture means) can be determined on the basis of corresponding scan data (see above explanations regarding scanning the tooth or hole, which are here applicable by analogy).

A special embodiment may e.g. be configured in the following way: A tooth to be extracted is scanned by X-ray computer tomography and a data set generated therefrom, which describes the shape of the tooth or the hole, is loaded into a computer with which the implant is modeled. The computer analyzes the data and suggests a plane 22 that is positioned at the tooth neck. The shape underneath the plane 22 is adopted in unchanged form for the shape of the implant. As for the part above plane 22, the software searches in a database for a suitable and predefined set of shape data which defines a part of the implant that can be veneered. The predetermined set of shape data is adapted in size and shape automatically or by hand and/or is positioned and connected to the set of part data underneath the plane 22 so as to obtain an individual data set which describes e.g. an implant as in FIG. 5.

Such a data set can be sent to a manufacturing center for denture parts and can there be manufactured in a CAM method. Subsequently, it may be veneered in addition and/or further processed in another way.

In a method a tooth is extracted from a patient and a fabricated implant as described in this application is inserted directly thereafter, i.e., e.g. within a period of not more than one hour, one day or five days.

1. A method comprising modeling an individual implant taking into account the individual shape of a tooth and/or a hole in a jawbone.

2. The method according to claim 1, wherein the individual shape of the tooth or the hole in the jawbone is stored in a data set and the data set is used by a software for modeling the implant.

3. The method according to claim 2 wherein the data set is created by scanning an extracted tooth or by scanning a tooth that has not been extracted yet or by scanning the hole.

4. The method according to claim 2, wherein the data set of the tooth or the hole in the jawbone is displayed during modeling of the implant.

5. The method according to claim 2, wherein a proposal for the shape of that part of the implant that matches the shape of the root/roots or parts of the root/roots of the tooth is automatically generated.

6. The method according to claim 5, wherein the automatically generated proposal takes into account the insertability of the implant, and/or insertability is automatically checked for the automatically generated proposal.

7. The method according to claim 5, wherein a plurality of proposals are automatically generated, with at least two proposals showing a different number of individual parts.

8. The method according to claim 1, wherein a surface roughness or a surface structure is provided for the implant.

9. The method according to claim 1, wherein the modeling yields a data set indicative of the shape of the implant.

10. The method according to claim 1, wherein a predetermined data set is used for that part of the implant on which an abutment or another mounting is to be installed.

11. The method according to claim 1, wherein modeling takes into account a data set that depicts at least a part of the shape of the jawbone into which the implant is to be inserted.

12. The method according to claim 1, wherein a counterpart is modeled for the implant, which counterpart can be temporarily mounted on an outwardly oriented part comprising a masticatory surface, that part on which an abutment or another mounting is to be installed, or on which a cover is to be provided.

13. The method according to claim 1, wherein a tooth root substitute portion of the implant is integrally connected to an implant portion which is intended for veneering or which is intended for connection to an abutment or another mounting or which is already provided with a masticatory surface.

14. The method according to claim 1, wherein the implant is directly modeled with its masticatory surface and/or is modeled such that it is identical in shape completely or at least completely in the portion of the tooth crown with the original tooth or with a complete tooth according to the tooth position.

15. The method according to claim 1, wherein means for disoccluding the implant, and/or means for connecting the implant to one or a plurality of neighbors are modeled together with the implant.

16. A method comprising modeling an individual implant according to claim 1 and subsequently manufacturing it with a CAM method.

17. The method according to claim 16, wherein a counterpart is manufactured together with the implant or in a separate manufacturing process, the counterpart being modeled for the implant, and which counterpart can be temporarily mounted on an outwardly oriented comprising a masticatory surface, that part on which an abutment or another mounting is to be installed, or on which a cover is to be provided, and/or
a means or a plurality of means is manufactured together with the implant or in a separate manufacturing process, the means comprising means for disoccluding the implant and/or means for connecting the implant to one or a plurality of neighbors that are modeled together with the implant

18. The method according to claim 16, wherein the implant is made from ceramic and is subsequently dense-sintered, or that the implant is made from titanium.

19. A computer-readable medium with instructions to a computer for executing the methods according to claim 1.

20. A computer with a computer-readable data carrier according to claim 19.

21. The method of claim 3, wherein the scanning is with one or more of an optical or mechanical probe, or by optical, mechanical or computer tomography.

22. The method of claim 4, wherein the surface of the tooth or the hole in the jawbone is shown in a spatial view to be transparent or nontransparent, or one or more sections of the tooth or the hole in the jawbone are shown.

23. The method of claim 7, wherein one proposal provides for a one-part implant and at least one proposal for a two- or three-part implant.

24. The method of claim 8, wherein the part of the implant intended for insertion into the bone is provided with the surface roughness or the surface structure.

25. The method of claim 12, wherein the counterpart is used as an aid for inserting the implant into the jawbone.

26. The method of claim 12, wherein the counterpart is individually matched in its shape to the implant.

27. The method of claim 18, wherein the implant is made by milling.
